(19) United States
(12) Patent Application Publication
(10) Pub. No.: US 2002/0073112 A1
(43) Pub. Date: Jun. 13, 2002

(54) Related documents processing device, recording medium for processing related documents and method for processing related documents

(75) Inventor: Chikako Kariya, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 09/938,485

(22) Filed: Aug. 27, 2001

(30) Foreign Application Priority Data
Dec. 8, 2000 (JP) 2000-373784

(51) Int. Cl. G06F 17/00

(52) U.S. Cl. 707/500; 707/6

(57) ABSTRACT

A related documents processing device includes a detector for detecting relevance among documents and a locater for locating a timewise latest document related to a document selected based on detected relevance information.

### CROSS-REFERENCE TO RELATED APPLICATIONS

The present application claims priority under 35 U.S.C. §119 to Japanese Patent Application No. 2000-373784, filed Dec. 8, 2000, entitled “Related Documents Processing Device and Recording Medium.” The contents of that application are incorporated herein by reference in their entirety.

### BACKGROUND OF THE INVENTION

1. Field of the Invention

The present invention relates to a related documents processing device, a computer readable recording medium with a related documents editing program recorded thereon, and a method for processing related documents.

2. Discussion of Background

Electric mail, which has been rapidly widespread for the recent years, has been establishing an important place as a business tool, and many persons exchange messages directly related to business on many occasions by electronic mail. This is also certainly applied to a case wherein persons privately exchange messages by electronic mail as a communication tool.

FIG. 12 is a schematic view showing a flow of response in ordinary electronic mail. First electronic mail 4 branches into two pieces of response mail (4-1 and 4-2). The response mail 4-1 includes a response message wherein all the contents of the first mail 4 are added (quoted) with a sign, such as “<”, marked at the head of each line for instance. The response mail 4-1-1 includes a response message wherein the contents of the response mail 4-1 are not added (quoted). The other response mail 4-2 branched from the first mail 4 includes a response message wherein the contents of the first mail 4 are not added (quoted).

When such response is repeated, it is not necessarily possible to see the details in the previous messages by reading only the latest electronic mail. This is because some electronic mail messages are prepared so that the contents of a preceding electronic mail message are not quoted and portions unnecessary to the sender are related as in the example stated above. Accordingly, it is necessary to skim through all deleted electronic mail messages.

In that case, the flow of exchange and the contents of electronic mail messages are grasped, catching the relevance of messages in reliance on the common subject and the reference indicative of response (e.g., Re:) since response messages have the common subject put as the heading and the reference added.

However, to grasp the flow of exchange and the contents of electronic mail messages, relying on the subject and the reference to catch the relevance of electronic mail messages, becomes difficult as the number of the electronic mail messages increases. This is because the electronic mail messages includes branched messages as stated earlier. From this viewpoint, it is not simple to find out the electronic mail message to respond.

In this case, it is necessary to find out the target message in reliance on not only the subject and the reference but also time (included in, e.g., header information) and the contents of the messages. Anyway, it is necessary to read through the electronic mail messages one after another, which is significantly troublesome to users.

The present invention is proposed in consideration of the problems stated earlier. It is an object of the present invention to provide a related documents processing device, and a method for processing related documents capable of easily grasping the flow of exchange (relevance) among documents having a certain relevance, and eliminating a wasteful job for reading through all related documents while investigating the sequence in relevance of the related documents, thereby to establish an effective job. In particular, the present invention can be applied to electronic mail documents exchanged with respect to a specific subject to easily find out an electronic mail document to respond, simply grasping the contents and the flow of the exchanged mail documents, for instance.

According to a first aspect of the present invention, the related documents processing device according to the present invention is characterized to comprise a detector for detecting relevance among documents and a locater for locating a timewise latest document related to a document selected based on detected relevance information.

In the first aspect of the present invention, the detector detects the relevance among the documents based on header information or other information included in the documents. Based on the detected relevance information, the locator locates the timewise latest document related to the selected document. By locating the timewise latest document related to the selected document based on the selected document, it become possible to easily grasp the contents of the consequence at the present time or another matter (including final conclusion etc.) among the related documents and to find out a mail document to respond without trouble in the case of, for instance, electronic mail documents.

Although, e.g., electronic mail documents are applicable to the documents recited in the arrangement, the documents are not limited to the electronic mail documents, and documents having a certain file format, for instance, are also applicable.

The meaning of the expression “among documents” is not only “among a plurality of independent documents” but also “among the contents of a plurality of documents stored in a file and managed as independent information”. In the case of pieces of electronic mail software as in the embodiments stated later, some of them manage respective mail documents as independent files, and some of them store all mail documents (an incoming mail document, an outgoing mail document, a drafted mail document etc.) in a single file and make a presentation as the incoming mail document, the outgoing mail document and the drafted mail document, using the attributes (incoming, outgoing, drafted etc.) of the mail documents. It is needless to say that the expression “among documents” covers “among such mail documents”.

The header information may be time information or IDs noted in the respective documents according to a uniqueness rule. The meaning of the uniqueness rule is that respective pieces of information have different IDs. When the time information is included in the header information, the detector detects a timewise order of the documents based on the time information. When the ID of a certain document and the IDs of the documents related to the certain document are included in the header information, the detector can detect the relationship among the documents (including relevance, such as the branched state between the documents). Based on the header information, the detector sorts out the relationship among the documents and outputs the result of the sort as relevance information to the locator. The locator locates the timewise latest document related to the selected document according to a certain rule (a timewise order or relevance based on IDs parallel noted).

When the header information of each of the documents includes the time information, the detector can detect a timewise order of the documents based on the time information of each of the documents and outputs relevance information including at least the timewise order. In particular, when the header information includes time information on preparation or modification of documents to be dealt with, the detector can detect a timewise order of the documents based on the time information in the header information of each of the documents and outputs relevance information including at least the timewise order.

The related documents processing device may further comprise a display unit to display the contents of a document located by the locator if there is such a document.

The display unit may have a function to display the relevance among the documents as a tree view based on the relevance information detected by the detector. In this case, a specific document selected among the documents displayed as a tree view by the display unit is processed as the selected document at the locator.

When the detector detects the branched state between the documents based on the ID noted in the header information according the uniqueness rule in each of the documents and outputs relevance information including at least the detected branched state, the display unit can also display the relevance among the documents including the detected branched state as a tree view.

When the documents are electronic mail documents, there can be a case wherein the relevance information detected by the detector is an exchange history of the electronic mail documents. In this case, the timewise latest electronic mail document located by the locator is subjected to a return mail processing.

The detector may detect a timewise order of the documents based on time information in the header information of each of the documents and outputs relevance information including at least the timewise order, and the display unit may display the timewise latest document among the documents related to a specific document that is selected among the documents displayed as a tree view (is selected by clicking a pointing device and the like). By adopting such arrangement, it becomes possible not only to visually display the relevance among the documents but also to easily grasp the contents of the consequence at the present time or another matter (including final conclusion etc.) among the related documents. In the case of electronic mail documents, for instance, it becomes possible to find out a mail document to respond without trouble.

As stated earlier, the header information may include an ID or the like noted in each of the documents according to the uniqueness rule or time information on preparation or modification of documents to be dealt with. In this case, the detector detects the branched state between the documents based on the ID noted in the header information according the uniqueness rule in each of the documents, detects a timewise order of the documents based on the time information in the header information of each of the documents, and outputs relevance information including at least the detected branched state and the timewise order. When the display unit displays the relevance among the documents including the detected branched state as a tree view, and when a specific document is selected among the documents displayed as the tree view, the contents of the timewise latest document among the documents related to the selected document is displayed.

According to a second aspect of the present invention, the related documents processing device according to the present invention is characterized to comprise a detector for detecting relevance among documents and a document editor for parsing an overlapped portion among related documents based on detected relevance information and for merging the related documents with the overlapped portion eliminated.

In the second aspect, the related documents can be edited into a single document so that the overlapped portion is eliminated according to a certain rule and that all the contents of the related documents can be read at a glance.

When the document editor carries out the editing operation in a way to merge the related documents according to an order of the related documents, it becomes easy to read the related documents.

As the manner for the document editor to make the document editing operation, there is proposed that the document editor not only determine an order of the related documents based on the relevance information detected by the relevance detector but also parse an overlapped portion in the related mail documents, and that if a later document contains a part or the entire part of the contents of an earlier document, the document editor merge the documents with the overlapped portion eliminated from the later or the earlier document.

The merged document thus provided by the editing is a document having a series of successive fashion and having no overlapped portion. As a result, it becomes possible to effectively grasp the contents of the documents and see a series of flow of the documents without reviewing all the documents. When the documents are, for example, electronic mail documents, it becomes possible to effectively grasp the contents and the flow of all exchanged mail documents without reading through all response mail documents. Thus, it becomes possible to eliminate a wasteful job for reading through all related response mail documents, making the operation effective.

It is needless to say that if each of the documents includes header information, the detector can detect the relevance among the documents based on the header information. In this case, the header information may include time information or an ID noted in each of the documents according to the uniqueness rule. When the time information is included in the header information, the detector can detect a timewise order of the documents based on the time information. When the ID of a certain document and the IDs of the documents related to the certain document are included in the header information, the detector can detect the relationship among the documents (including relevance, such as the branched state between the documents). Thus, the detector can sort out the relationship among the documents based on the header information and outputs the results of the sort as relevance information to the document editor. The document editor parses an overlapped portion between the documents based on the relevance information and merges the documents with the overlapped portion eliminated.

When the header information of each of the documents includes the time information, the detector can detect a timewise order of the documents based on the time information of each of the documents and outputs relevance information including at least the timewise order. In particular, when the header information includes time information on preparation or modification of documents to be dealt with, the detector can detect the timewise order of the documents based on the time information in the header information of each of the documents and outputs relevance information including at least the timewise order.

The arrangement according to this aspect may include a display unit, which displays the relevance among the documents as a tree view based on the relevance information detected by the detector.

When such a display unit is included, the document editor may merge documents from a document selected among the documents displayed as a tree view by the display unit up to the timewise latest document related to the selected document, and the display unit may have a function to display the merged document.

The detector may detect a branched state between documents based on an ID noted in the header information according the uniqueness rule in each of the documents as stated earlier and output relevance information including at least the detected branched state, and the document editor may parse an overlapped portion between the documents based on the relevance information and merge the documents with the overlapped portion eliminated.

When the detector detects the branched state between the documents based on the ID noted in the header information according the uniqueness rule in each of the documents and outputs relevance information including at least the detected branched state as stated earlier, the display unit may display the relevance among the documents including the detected branched state as a tree view.

When the documents are electronic mail documents, there can be a case wherein the relevance information detected by the detector is an exchange history of the electronic mail documents. In this case, it is easy to eliminate the overlapped portion by the document editor since the relevance among the documents can be clarified based on the exchange history.

According to a third aspect and a fourth aspect of the present invention, there are provide recording media with a program executable in a computer stored therein for having a computer executed the constituent elements in each of the first and the second aspect. Specifically, as the solution to solve the problems, there are provided recording media with a program readable by and executable in a computer stored therein, which can use the structure of a computer to realize the respective constituent elements. In this case, the computer may be a general purpose computer including a central processing unit or a dedicated purpose computer for a specific processing. There is no particular limitation as long as the computer includes a central processing unit.

When a program for having a computer served to realize the respective constituent elements is read out by a computer, structures similar to the constituent elements recited in the first aspect or the second aspect can be provided.

Such recording media can be easily distributed or sold as software products. By executing such software in an existing hardware resource, it becomes possible to easily execute the system of the present invention as a new application in the existing hardware. It is needless to say that an internal storage, such as a RAM and a ROM, and an external storage, such as a hard disk in addition to these recording media are included in the recording media covered by the present invention as long as the program stated earlier is recorded in these storages.

One of the constituent elements recited in the third aspect or the fourth aspect may be realized by a function incorporated into a computer (a function incorporated as a part of a hardware in a computer, or a function realized by the operating system incorporated in a computer, another application program or the like), and the program stored in the recording medium in the third aspect or the fourth aspect may include a command to call or link to the function to be provided by the computer.

This is because substantially similar arrangement can be provided as long as one of the constituent elements recited in the first aspect or the second aspect is taken over by a part of the functions attained by, e.g., the operating system and as long as the part of the functions of the operating system for attaining the functions can be configured to be called or linked, though neither program nor module for realizing that function is directly recorded on a recording media.

The third aspect corresponds to the first aspect and provides a computer readable recording medium having a program recoded thereon, the program making a computer function as a detector for detecting relevance among documents and a locator for locating a timewise latest document related to a document selected based on detected relevance information.

The fourth aspect corresponds to the second aspect and provides a computer readable recording medium having a program recoded thereon, the program making a computer function as a detector for detecting relevance among documents and a document editor for parsing an overlapped portion among related documents based on detected relevance information and for merging the documents with the overlapped portion eliminated.

According to a fifth aspect and a sixth aspect of the present invention, there are provided methods for processing related documents which respectively, correspond to the first aspect and the second aspect.

Specifically, according to the fifth aspect, there is provided a method for processing related documents, which comprises a detecting step of relevance among documents; and a locating step of locating a timewise latest document related to a document selected based on detected relevance information.

According to the sixth aspect, there is provided a method for processing related documents which comprises a detecting step of detecting relevance among documents; and a merging step of parsing an overlapped portion among related documents based on detected relevance information and merging the documents with the overlapped portion eliminated.

As explained, the related documents processing device, the recording medium and the method for processing related documents according to the present invention can offer advantages that it becomes possible to easily grasp the relevance among documents having a certain relevance and to eliminate a wasteful job, such as a job for reading through all related documents while investigating the sequence in relevance of the related documents, thereby to establish an effective job.

In particular, the present invention can be applied to electronic mail documents exchanged with respect to a specific subject to easily find out an electronic mail document to respond, simply grasping the contents and the flow of the exchanged mail documents without reading through the respective exchanged electronic mail documents one after another.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanied drawings, wherein:

FIG. 1 is a schematic view showing the outline of a related documents processing device wherein the related documents processing device for electronic mail according to the present invention is constructed in a computer;

FIG. 2 is a functional block diagram of the related documents processing device of FIG. 1;

FIG. 3 is a view showing the relationship among a group of response mail documents as an example;

FIG. 4 is a schematic view showing, as an example, how to indicate Message-IDs and References included in the header information of the respective mail documents of FIG. 3;

FIG. 5 is a functional block diagram showing a case wherein the related documents processing device for electronic mail according to a second embodiment of the present invention is constructed in a computer;

FIG. 6 is a schematic view showing how the files of a group of related mail documents on a mailer application are displayed on a display device;

FIG. 7 is a functional block diagram showing a case wherein the related documents processing device for electronic mail according to a third embodiment of the present invention is constructed in a computer;

FIG. 8 is a schematic view showing, as an example, how to edit a grouped series of related mail documents by document editor based on a result of relevance detection conducted by a relevance detector;

FIG. 9 is a flowchart showing steps in the editing process shown in FIG. 8;

FIG. 10 is a schematic view showing how to edit a grouped series of related mail documents by a document editor, the related mail documents including branched mail documents;

FIG. 11 is a schematic view showing the relationship between the contents of respective exchanged mail documents and a merged message with the contents merged therein; and

FIG. 12 is a schematic view showing the ordinary flow in response of electronic mail documents.

### DETAILED DESCRIPTION OF THE PREFERRED EMBODIMENTS

The preferred embodiments of the present invention will now be described with reference to the accompanying drawings, wherein like reference numerals designate corresponding or identical elements throughout the various drawings.

Embodiment 1

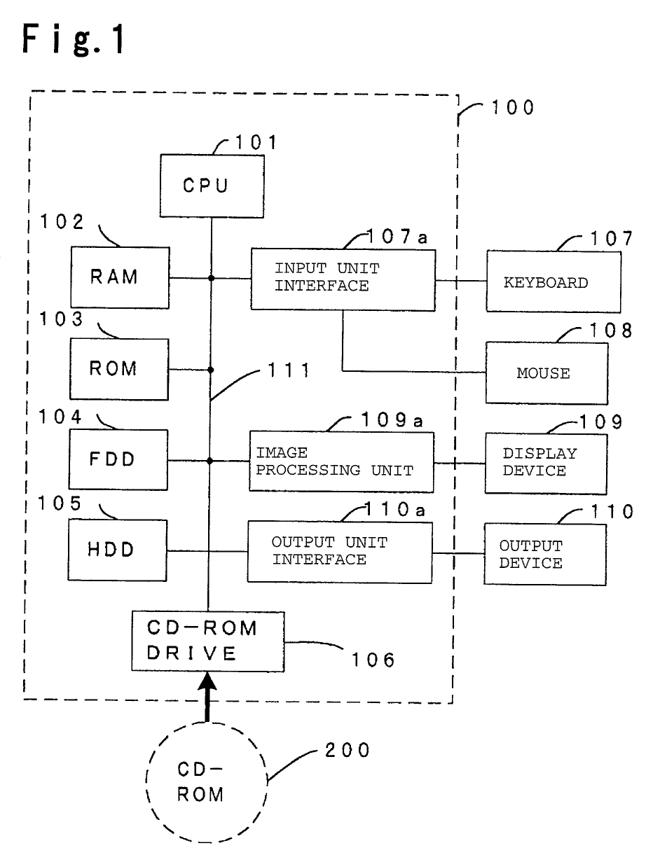

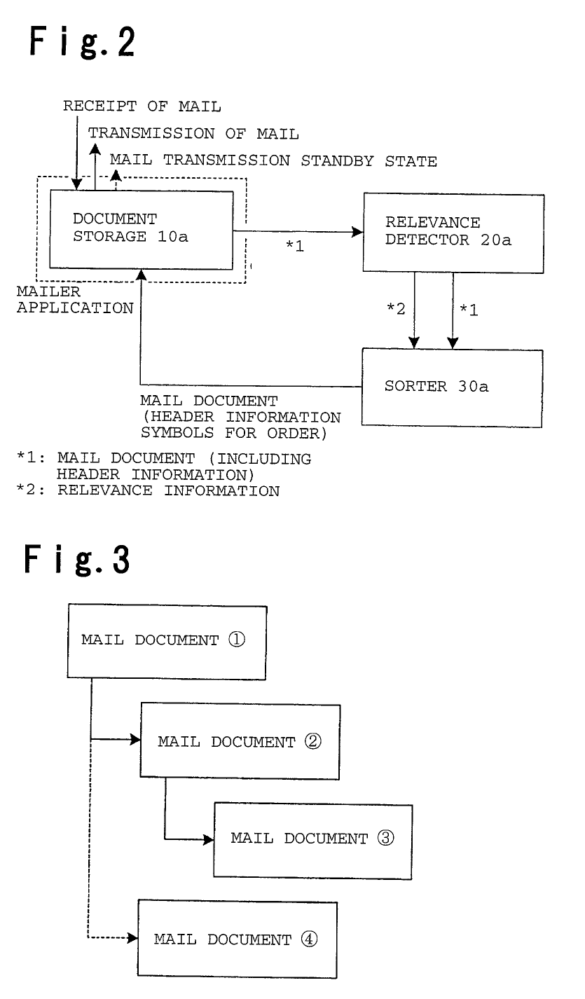

FIGS. 1 and 2 are a schematic view of a related documents processing device and a functional block diagram wherein the related documents processing device for electronic mail according to the present invention is constructed in a computer 100 when a certain mailer application program and the related documents editing program according to the present invention written on a CD-ROM 200 are read out by the computer and executed in the computer.

As shown in FIG. 1, the computer 100 is, as usual, configured to include a system bus 111, a CPU 101 connected thereto, RAM 102 connected thereto, a ROM 103 connected thereto, a floppy disk drive 104 connected thereto, a hard disk drive 105 connected thereto, a CD-ROM drive 106 connected thereto, a keyboard 107 and a mouse 108 connected thereto through an input unit interface 107a, a display device 109, such as a display, connected thereto through an image processing unit 109a, and an output device 110, such as a printer, connected thereto through an output unit interface 110a. When the CD-ROM 200 with a certain electronic mail application program (hereinbelow referred to as the mailer application) and the related documents editing program according to the present invention written thereon is put into the CD-ROM drive 106, and when these programs are read out and executed in the computer 100, the related documents processing device according to the present invention is constructed on the mailer application.

Although explanation of this embodiment is made with reference to a case wherein a certain program is provided by the CD-ROM 200, the provision of the program is not limited to this fashion. The program may be provided by another recording medium or may be downloaded from another device through a network and be stored in the computer 100.

The related documents processing device on the mailer application is configured to include a document storage 10a, a relevance detector 20a and a sorter 30a as shown in FIG. 2.

Among these elements, the document storage 10a also serves as a file memory structure (not shown) for incoming electronic mail, outgoing electronic mail, electronic mail in a transmission standby status (or drafted electronic mail) and others in the mailer application and comprises an internal storage, such as the RAM 102, and an external storage, such as the hard disk drive 105. The respective pieces of electronic mail include at least time information, such as the receiving time of the incoming mail documents, and the preparing time or the transmitting time of the outgoing mail, status information for discriminating whether each of the mail documents is an incoming one, an outgoing one or one in a transmission standby status, and Message-ID information as header information.

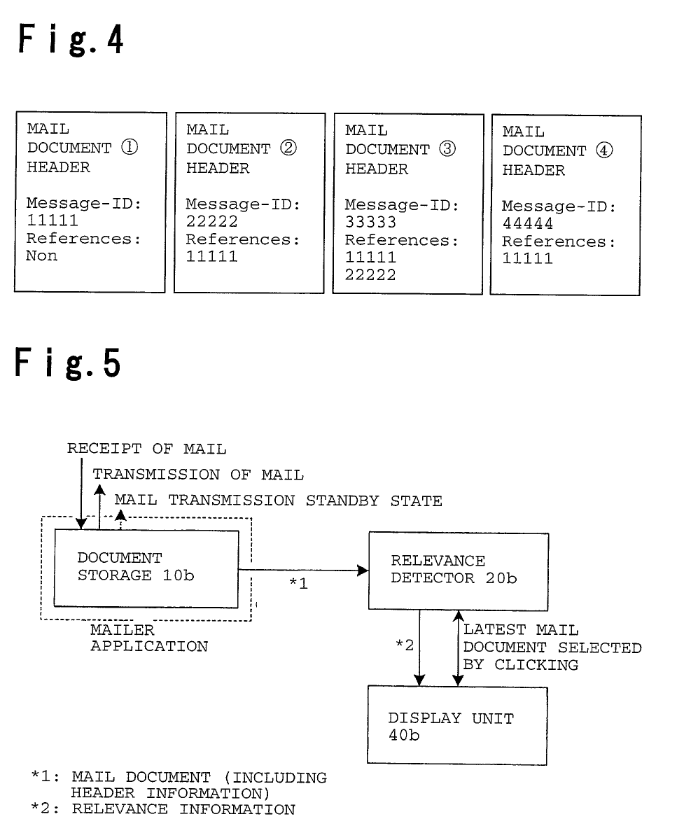

The Message-IDs are noted in the respective mail documents according to the uniqueness rule, in the form, e.g., “11111”, “22222”, “33333” and “44444”, as shown in FIG. 4, which will be described later. Each header information includes “References” showing to which electronic mail the corresponding mail is response mail (related), in addition to the corresponding Message-ID.

The relevance detector 20a includes a detector for detecting the relevance among documents based on the header information of the documents and a locator for locating the final document in a timewise sense among documents selected based on detected relevance information. The relevance detector comprises the CPU 101 and the RAM 102 for providing the CPU with a working area. In the detection processing of the relevance among the documents, the branched state among the mail documents is detected based on the Message-IDs and the References noted in the header information of the respective mail documents, and the timewise order is also detected based on the time information in the header information. After having completed the detection processing, the relevance detector 20a outputs the results of the processing as relevance information.

The sorter 30a is configured to rearrange or sort out the mail documents based on the detected relevance information. The sorter also comprises the CPU 101 and the RAM 102 for providing the CPU with a working area. The sorting process carried out in the sorter is processing for sorting out the mail documents based on the detected branched status and the detected timewise order. The result of the sorting is added to the header information in the respective mail documents as certain symbols for order (e.g., natural numbers) indicative of the sorted order and is stored in the document storage 10a.

FIGS. 3 and 4 are a view showing the relationship among response mail documents and a schematic view showing, as an example, how to indicate the Message-IDs and the References included in the header information of the respective mail documents. In these figures, a mail document \mathring{1} is a first mail document, wherein “11111” is noted in the “Message-ID”, and no Message-ID information on related mail documents is not noted in the “References”. A mail document \mathring{2} is a response mail document to the first mail document \mathring{1} s shown in FIG. 3, wherein “22222” is noted in the “Message-ID”, and “11111” as the Message-ID information of the first mail document \mathring{1} as a related mail document is noted in the “References”. A mail document \mathring{3} is a response mail document to the second mail document \mathring{2} as shown in FIG. 3, wherein “33333” is noted in the “Message-ID”, and “22222” as the Message-ID information of the second mail \mathring{2} as a related mail document is noted in the “References”. A mail document \mathring{4} branches from the mail document \mathring{2} and is a response mail document to the first mail document \mathring{1} as shown in FIG. 3, wherein “44444” is noted in the “Message-ID”, and “11111” as the Message-ID information of the first mail \mathring{1} as a related mail document is noted in the “References”.

The relevance detector 20a detects the relevance among the mail documents and the branched state of the mail documents, detects the timewise order among the respective mail documents and outputs the detected relevance and the detected timewise order to the sorter 30a as relevance information as explained. By the sorting processing in the sorter 30a, a group of relative mail documents can be timewise sorted in the order of their closer relevance while reflecting a branched state if any.

As explained, the results of the sorting are added as certain symbols for order to the header information. When a user uses the mailer application to look into the files of the mail documents, the files of the mail documents are displayed in fashion sorted according to the order. If necessary, the user can click a certain mail document to display the contents of the mail document on the screen of the display device 109.

Embodiment 2

FIG. 5 is a functional block diagram showing a case wherein the related documents processing device for electronic mail according to the present invention is constructed in a computer 100 when a certain mailer application program and the related documents editing program according to the present invention written on a CD-ROM 200 are read out by the computer 100 and executed on the computer.

The hardware structure of the embodiment shown in FIG. 5 is identical to the one shown in FIG. 1, and detailed explanation of the hardware structure will be omitted.

The related documents processing device on the mailer application is configured to include a document storage 10b, a relevance detector 20b and a display unit 40b as shown in FIG. 5.

Since the document storage 10b and the relevance detector 20b among these elements are identical to the document storage 10a and the relevance detector 20a stated earlier, detailed explanation of the document storage and the relevance detector will be omitted.

The display unit 40b is configured to display the relevance among the documents as a tree view based on detected relevance information. The display unit comprises the CPU 101, the RAM 102 and the display device 109. The CPU 101 provides the RAM 102 with image information with the relevance reflected therein, and the image information is displayed on the screen of the display device 109.

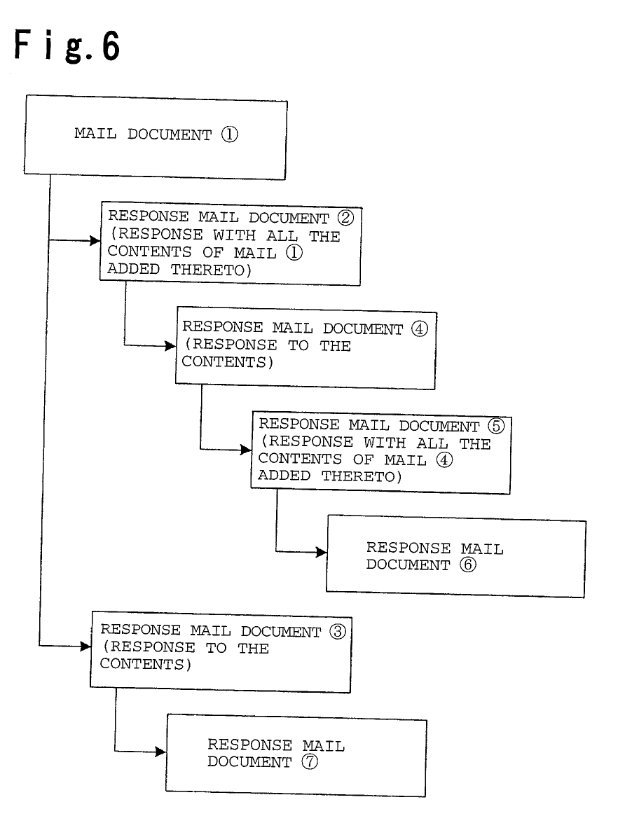

FIG. 6 shows how the files of a group of related mail documents on the mailer application are displayed on the display device 109 by the arrangement stated above. In this figure, it is shown that a mail document \mathring{1} is a first mail document, that the response mail to the first mail document branches into two mail documents \mathring{2} and \mathring{3}, that a response mail document \mathring{4} to the mail document \mathring{2}, a response mail document \mathring{5} to the response mail document \mathring{4} and a response mail document \mathring{6} to the response mail document \mathring{5} are related mail documents, and that a response mail document \mathring{7} to the mail document \mathring{3} is a related mail document.

In addition, the display unit 40b serves so that, when a user clicks, e.g., the mail document \mathring{2} among the electronic mail documents displayed on the display device, the display unit specifies the latest mail document in a timewise sense among mail documents related to the clicked mail document based on relevance information outputted from the relevance detector 20b, and the display unit displays the contents of the latest mail document as the mail document \mathring{6} to respond. If the user clicks the mail document \mathring{3}, the display unit 40b displays the contents of the mail document \mathring{7} to respond. The function setting of the display unit 40b may be modified to display the contents of the clicked mail document \mathring{2} as it is.

By the arrangement stated above, the relevance detector 20b detects the relevance among the mail documents and the branched state of the mail documents, detects the timewise order among the respective mail documents and outputs the detected relevance and the detected timewise order to the display unit 40b as relevance information as explained. The display unit 40b can display a group of relative mail documents as file icons indexing the respective mail documents so that the relative mail documents are timewise sorted in the order of their closer relevance while reflecting a branched state if any. The display unit can display the relationship among the respective file icons as a tree view using charts so that the relevance among the file icons including the branched state of the file icons is shown.

When a user clicks a certain mail document as explained, the display unit 40b can receive the relevance information detected by the relevance detector 20b to specify the latest mail document among the mail documents related to the clicked mail document, displaying the contents of the latest mail document as the mail document to respond.

Embodiment 3

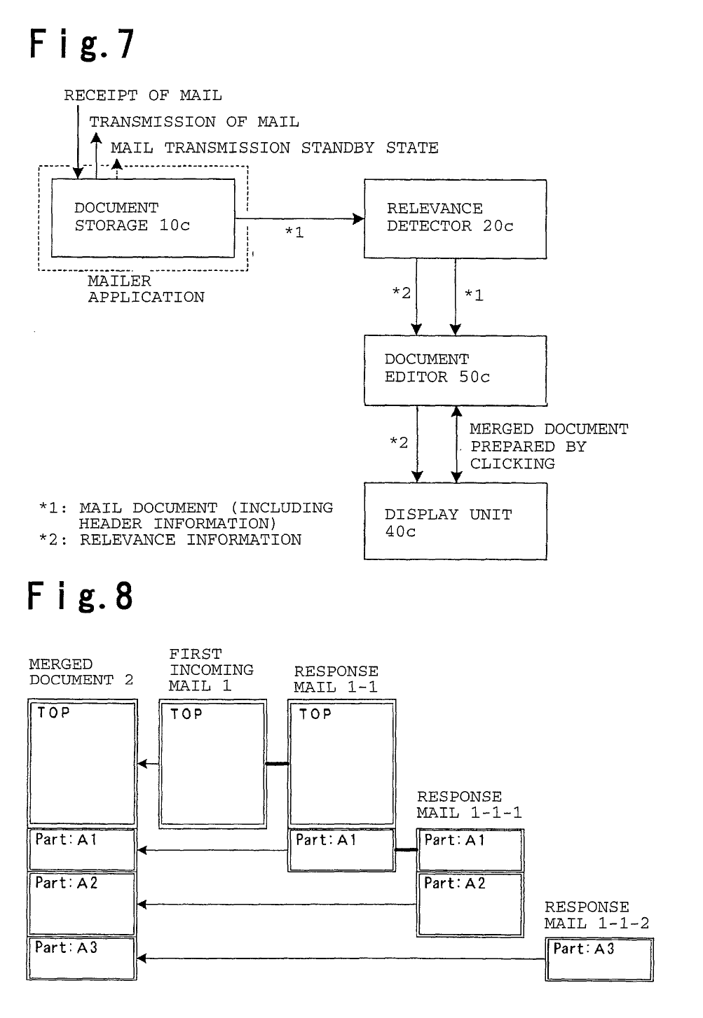

FIG. 7 is a functional block diagram showing a case wherein the related documents processing device for electronic mail according to the present invention is constructed in a computer 100 when a certain mailer application program and the related documents editing program according to the present invention written on a CD-ROM 200 are read out by the computer 100 and executed on the computer.

The hardware structure of the embodiment shown in FIG. 7 is identical to the one shown in FIG. 1, and detailed explanation of the hardware structure will be omitted.

The related documents processing device on the mailer application is configured to include a document storage 10c, a relevance detector 20c and a document editor 50c as shown in FIG. 7.

Since the document storage 10c and the relevance detector 20c among these elements are identical to the ones in the first embodiment, detailed explanation of the document storage and the relevance detector will be omitted.

The document editor 50c provides arrangement that merges related mail documents to modify the merged documents into a single mail document for a user to easily read the related mail documents (to grasp the contents and the flow of exchange of the related mail documents). The document editor 50c comprises the CPU 101, the RAM 102 for providing the CPU with a working area, and another element. The document editor 50c has a document editing function that the document editor determines an order (a timewise order including a branched state) of the related mail documents based on the relevance information detected by the relevance detector 20c, and that when a later mail document contains a part or the entire part of the contents of an earlier mail document, the document editor parses an overlapped portion in the related mail documents and not only eliminates the overlapped portion from the later (or the earlier) mail document but also merges the mail documents.

Although the display unit 40c is almost similar to the display unit 40b in terms of structure, the display unit 40c has a characteristics function in that when a user clicks a specific mail document among the mail documents displayed as a tree view, the display unit displays the merged document so as to cover the mail documents up to the latest mail document related to the clicked mail document. Specifically, the display unit 40c passes the mail documents related to the clicked mail document from the clicked mail document up to the latest mail document related thereto to the document editor 50c. When the document editor edits the passed mail documents into a merged document and return the merged document to the display unit 40c, the display unit displays the merged document on the screen of the display device 109.

FIG. 8 shows, as an example, how to edit a grouped series of related mail documents by the document editor 50c based on the results of relevance detection conducted by the relevance detector 20c. In this figure, first incoming mail 1 has the contents of the mail document indicated by TOP. The response mail 1-1 to the first incoming mail includes a responded passage indicated by Part: A1 and the contents TOP (normally having the head noted with a symbol for meaning quotation, such as “>”,) of the first incoming mail 1. The response mail 1-1-1 to the response mail 1-1 includes a responded passage to the response mail 1-1 indicated by Part: A2 and the contents Part: A1 of the response mail 1-1. The response mail 11-2 to the response mail 1-1 includes only a responded passage to the response mail 1-1 indicated by Part: A3.

The relevance among the related documents has already been detected by the relevance detector 20c at this stage. The document editor 50c, which has received the relevance information, performs the function stated earlier to edit the related mail documents and produce the merged document. Specifically, the document editor carries out merging to extract unoverlapped portion from the mail document clicked and selected by a user and from the mail documents related to the selected mail document after the selected mail document in a timewise descending order. In detail, when the comparison of a mail document and the one just before that mail document or already merged data shows that the mail document in question includes the same contents as the one just before the mail document in question in succession (the position of the same contents varies on users and is located at the tail or the front in the mail document in question), the mail document in question is regarded as including an overlapped portion, the overlapped portion is eliminated from the mail document in question, and the remaining portion (a newly added message in the mail document in question) is merged into the one just before the mail document in question or the merged data. When this operation has been carried out throughout the entire mail documents related to the selected mail document, the merging is completed.

In the case stated earlier, the portion indicated by TOP, the portion indicated by Part: A1 with the portion indicated by TOP eliminated, the portion indicated by Part: A2 with the portion indicated by Part: A1, and the portion indicated by Part: A3 are respectively extracted from the first incoming mail 1, the response mail 1-1, the response mail 1-1-1 and the response mail 1-1-2, and the extracted portions are edited as a single merged document 2, being timewise rearranged or sorted out.

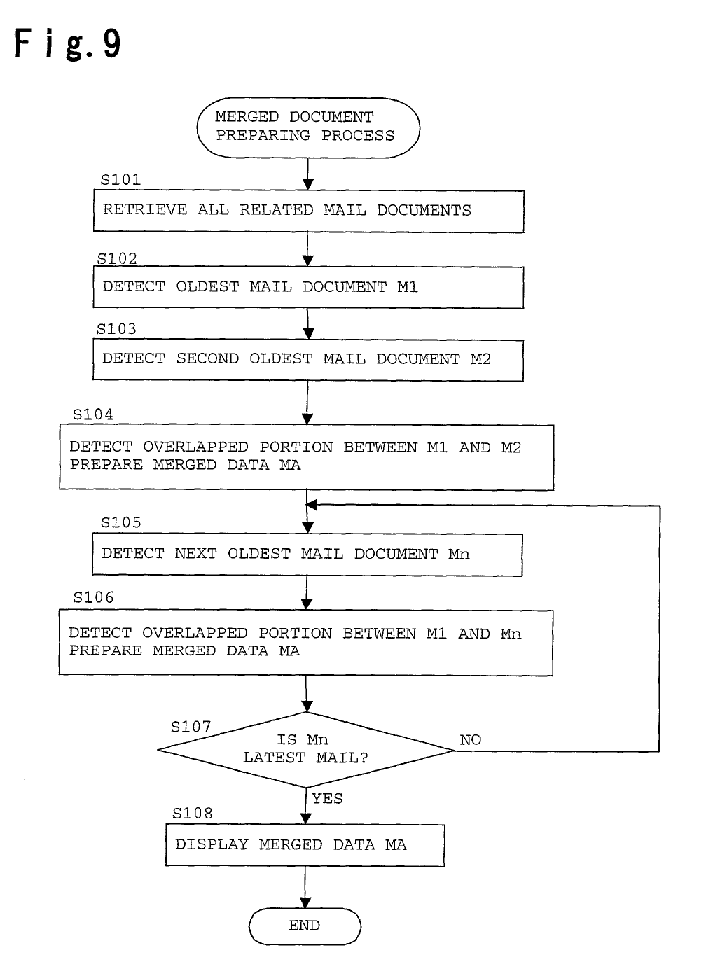

FIG. 9 is a flow chart showing the steps in the editing process stated earlier. First, the relevance detector 20c retrieves all related mail documents from the header information of the mail documents stored in the document storage 10c (Step S101).

Next, the oldest mail document M1 is detected among the related mail documents (Step S102). Then, the second oldest mail document M2 is detected (Step S103).

An overlapped portion between the mail document Ml and the mail document M2 is detected, and a merged data MA is prepared in such a manner to eliminate the overlapped portion from the mail document M2 (or the mail document M1) (Step S104).

The next oldest mail document Mn is detected (Step S105). An overlapped portion between the merged data MA and the mail document Mn is detected, and the merged data MA is prepared (renewed) in such a manner to eliminate the overlapped portion from the mail document Mn (Step S106).

It is checked whether the mail document Mn is the latest mail document or not (Step S107). If it is not the latest mail document (Step S107: No), the procedure returns to Step S105, and the operations stated above are repeated.

If it is determined at the Step S107 that it is the latest mail document (Step S107: Yes), the display device 40c displays the merged data MA on the screen (Step S108).

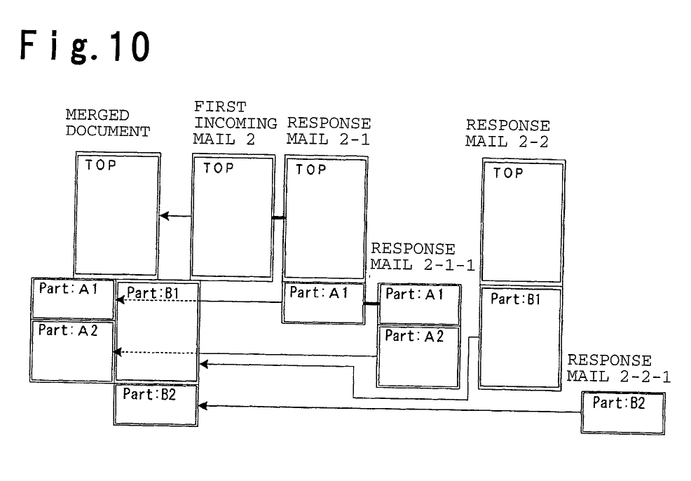

FIG. 10 shows, as an example, how to edit a grouped series of related mail documents with a branched mail document included therein by the document editor 50c. In this figure, first incoming mail 2 has the contents of the mail document indicated by TOP. The response mail 2-1 to the first incoming mail includes a responded passage indicated by Part: A1 and the contents TOP of the first incoming mail 2. The response mail 2-1-1 to the response mail 2-1 includes a responded passage to the response mail 2-1 indicated by Part: A2 and the contents Part: A1 of the response mail 2-1. The response mail 2-2 directed to the first incoming mail 2 and branched from the response mail 2-1 includes a responded passage to the first incoming mail 2 indicated by Part: B1 and the contents of the first incoming mail 2 indicated by TOP.

The response mail 2-2-1 to the response mail 2-2 includes only a responded passage to the response mail 2-2 indicated by Part: B2.

The relevance among the series of related documents with a branched state included therein has already been detected by the relevance detector 20c at this stage.

The document editor 50c, which has received the relevance information, performs the function stated earlier to edit the related mail documents and produce a merged document. In this case, data to merge can not be integrated in single fashion by the measures shown in FIG. 8 since the data to merge have branched fashion. For this reason, merged data are prepared in the same number as the number of branches. In other words, in this case, the portion indicated by TOP, the portion indicated by Part: A1 with the portion indicated by TOP eliminated, and the portion indicated by Part: A2 with the portion indicated by Part: A1 eliminated are, respectively, extracted from the first incoming mail 2, the response mail 2-1 and the response mail 2-2-1, and the extracted portions are edited as a single merged document A so as to be timewise rearranged or sorted out. In addition, the portion indicated by Part: B1 with the portion indicated by TOP eliminated and the portion indicated by Part: B2 are, respectively extracted from the response mail 2-2 and the response mail 2-2-1, and the extracted portion are edited as a single merged document B so as to be timewise rearranged or sorted out.

When the response mail documents have branched fashion, and when the merged results exist in the number of branches, it is preferable that not only the merged results for a selected mail document but also the merged results for a branched mail document can be listed on the display unit 40c so as to be browsed.

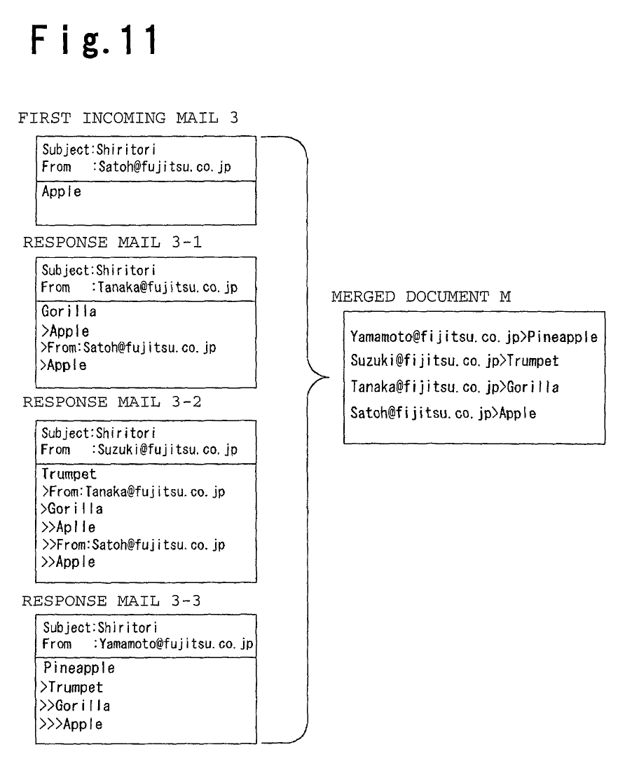

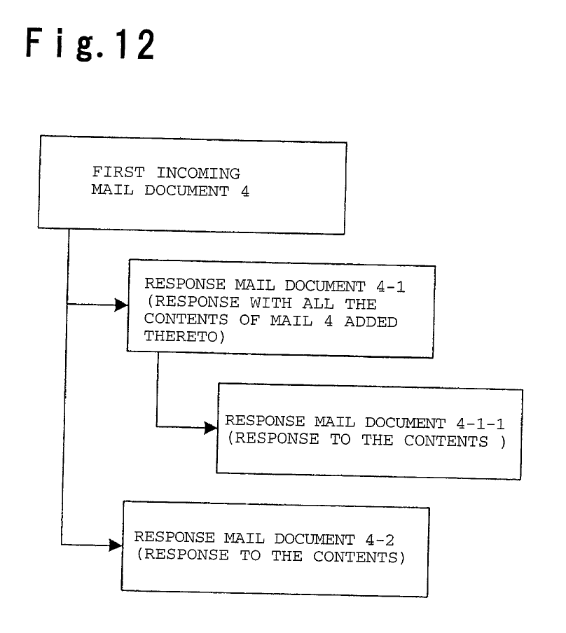

FIG. 11 is a schematic view showing the relationship between the contents of respective exchanged mail documents and a merged document (merged results). In this figure, the mail document of first incoming mail 3 includes the subject of “Shiritori”, the transmitter's name of Satoh@fujitsu.co.jp and the mail contents of “Apple”.

The mail document of the response mail 3-1 to the first incoming mail includes the same subject of “Shiritori”, the transmitter's name of Tanaka@fujitsu.co.jp, and the mail contents of “Gorilla”. In the response mail 3-1, below the mail contents of “Gorilla”, the quoted portion from the contents of the first incoming mail 3 is shown as “>Apple”, and below the mail contents of “Apple”, the indication of the transmitter's name of the first incoming mail 3 and the mail contents are shown as “>From: Satoh@fujitsu.co.jp (new line) >Apple”.

The mail document of the next response mail 3-2 includes the same subject of “Shiritori”, the transmitter's name of Suzuki@fujitsu.co.jp, and the mail contents of “Trumpet”. In the response mail 3-2, below the mail contents of “Trumpet”, the indication of the transmitter's name of the response mail 3-1 and the mail contents thereof are shown as “>From: Tanaka@fujitsu.co.jp (new line) >Gorilla (new line) >>Apple (new line) >>From: Satoh@fujitsu.co.jp (new line) >>Apple”.

The mail document of the next response mail 3-3 includes the same subject of “Shiritori”, the transmitter's name of Yamamoto@fujitsu.co.jp, and the mail contents of “Pineapple”. In the response mail 3-3, “Pineapple (new line) >Trumpet (new line) >>Gorilla (new line) >>>Apple” is shown in such fashion to quote “>Apple” as the mail contents of the first incoming mail 3, “Gorilla” as the mail contents of the response mail 3-1 and “Trumpet” as the mail contents of the response mail 3-3.

The merged document M that are provided by editing these mail documents at the document editor 50c has the contents of “Yamamoto@fujitsu.co.jp>Pineapple (new line) Suzuki@fujitsu.co.jp>Trumpet (new line) Tanaka@fujitsu.co.jp>Gorilla (new line) Satoh@fujitsu.co.jp>Apple” as shown in this figure. The merged document also includes the mail addresses of the writers in order to see by whom the respective messages have been sent. Only the character string before “@” in each of the mail addresses may be shown to see by whom each of the messages has been sent.

As explained, the arrangement according to this embodiment can provide a series of successive mail documents with an overlapped portion eliminated and display the editorial results as a single merged document. Thus, it becomes possible to effectively grasp the contents of these mail documents and see the series flow of the mail documents without reading through all mail documents. By such display, it becomes possible to easily find out the electronic mail to respond and to grasp the flow of the exchanged mail documents at a glance.

The related documents processing device, the recording medium and the method for processing related documents according to the present invention are not limited to the embodiments stated earlier. It is needless to say that variations and modifications are possible without departing the spirit of the invention. For example, the present invention may be applied to an outline processor, which arranges or sort out the plot (outline) of an idea to get the idea in shape, for the arrangement of written documents.

What is claimed is:

1. A related documents processing device comprising:
a detector detecting relevance among documents; and
a locater locating a timewise latest document related to a document selected based on detected relevance information.

2. The device according to claim 1, wherein the documents have header information, and the detector detects the relevance among the documents based on the header information.

3. The device according to claim 2, wherein the detector detects a timewise order of the documents based on time information in the header information of each of the documents and outputs the relevance information including at least a timewise order.

4. The device according to claim 1, further comprising a display unit for displaying contents of the document located by the locator.

5. The device according to claim 4, wherein the display unit displays the relevance among the documents as a tree view based on the relevance information detected by the detector.

6. The device according to claim 5, wherein a specific document selected among the documents displayed as a tree view by the display unit is processed as the selected document at the locator.

7. The device according to claim 2, wherein the detector detects a branched state between documents based on an ID noted in the header information according to a uniqueness rule in each of the documents and outputs the relevance information including at least the detected branched state.

8. The device according to claim 5, wherein the detector detects a branched state between documents based on an ID noted in the header information according to a uniqueness rule in each of the documents and outputs the relevance information including at least the detected branched state, and the display unit displays the relevance among the documents including the detected branched state as a tree view.

9. The device according to claim 1, wherein the documents are electronic mail documents, and the relevance information detected by the detector is an exchange history of the electronic mail documents.

10. The device according to claim 9, wherein a timewise latest electronic mail document located by the locator is subjected to a return mail processing.

11. A related documents processing device characterized in that it comprises:
a detector detecting relevance among documents; and
a document editor parsing an overlapped portion among related documents based on detected relevance information and for merging the documents with the overlapped portion eliminated.

12. The device according to claim 11, wherein the document editor merges the documents according to an order of the related documents.

13. The device according to claim 11, wherein the documents have header information, and the detector detects the relevance among the documents based on the header information.

14. The device according to claim 13, wherein the detector detects a timewise order of the documents based on time information in the header information of each of the documents and outputs the relevance information including at least the timewise order.

15. The device according to claim 11, further comprising a display unit for displaying the relevance among the documents as a tree view based on the relevance information detected by the detector.

16. The device according to claim 15, wherein the document editor merges documents from a document selected among the documents displayed as a tree view by the display unit up to a timewise latest document related to the selected document, and the display unit displays the merged document.

17. The device according to claim 13, wherein the detector detects a branched state between documents based on an ID noted in the header information according to a uniqueness rule in each of the documents and outputs the relevance information including at least the detected branched state.

18. The device according to claim 15, wherein the detector detects a branched state between documents based on an ID noted in the header information according to a uniqueness rule in each of the documents and outputs the relevance information including at least the detected branched state, and the display unit displays the relevance among the documents including the detected branched state as a tree view.

19. The device according to claim 11, wherein the documents are electronic mail documents, and the relevance information detected by the detector is an exchange history of the electronic mail documents.

20. A computer readable recording medium having a program recoded thereon, the program makes a computer function as:
a detector detecting relevance among documents; and
a locator locating a timewise latest document related to a document selected based on detected relevance information.

21. The recording medium according to claim 20, wherein the documents have header information, and the detector detects the relevance among the documents based on the header information.

22. The recording medium according to claim 21, wherein the detector detects a timewise order of the documents based on time information in the header information of each of the documents and outputs the relevance information including at least the timewise order.

23. The recording medium according to claim 20, wherein the program further makes the computer function as a display unit for displaying contents of the document located by the locator.

24. The recording medium according to claim 23, wherein the display unit displays the relevance among the documents as a tree view based on the relevance information detected by the detector.

25. The recording medium according to claim 24, wherein a specific document selected among the documents displayed as a tree view by the display unit is processed as the selected document at the locator.

26. The recording medium according to claim 21, wherein the detector detects a branched state between documents based on an ID noted in the header information according to a uniqueness rule in each of the documents and outputs the relevance information including at least the detected branched state.

27. The recording medium according to claim 24, wherein the detector detects a branched state between documents based on an ID noted in the header information according to a uniqueness rule in each of the documents and outputs the relevance information including at least the detected branched state, and the display unit displays the relevance among the documents including the detected branched state as a tree view.

28. The recording medium according to claim 20, wherein the documents are electronic mail documents, and the relevance information detected by the detector is an exchange history of the electronic mail documents.

29. The recording medium according to claim 28, wherein a timewise latest electronic mail document located by the locator is subjected to a return mail processing.

30. A computer readable recording medium having a program recoded thereon, the program making a computer function as:
a detector detecting relevance among documents; and
a document editor parsing an overlapped portion among related documents based on detected relevance information and merging the documents with the overlapped portion eliminated.

31. The recording medium according to claim 30, wherein the document editor merges the documents according to an order of the related documents.

32. The recording medium according to claim 30, wherein the documents have header information, and the detector detects the relevance among the documents based on the header information.

33. The recording medium according to claim 32, wherein the detector detects a timewise order of the documents based on time information in the header information of each of the documents and outputs the relevance information including at least a timewise order.

34. The recording medium according to claim 30, wherein the program further makes the computer function as a display unit for displaying the relevance among the documents as a tree view based on the relevance information detected by the detector.

35. The recording medium according to claim 34, wherein the document editor merges documents from a document selected among the documents displayed as a tree view by the display unit and up to a timewise latest document related to the selected document, and the display unit displays the merged document.

36. The recording medium according to claim 32, wherein the detector detects a branched state between documents based on an ID noted in the header information according to a uniqueness rule in each of the documents and outputs the relevance information including at least the detected branched state.

37. The recording medium according to claim 34, wherein the detector detects a branched state between documents based on an ID noted in the header information according to a uniqueness rule in each of the documents and outputs the relevance information including at least the detected branched state, and the display unit displays the relevance among the documents including the detected branched state as a tree view.

38. The device according to claim 30, wherein the documents are electronic mail documents, and the relevance information detected by the detector is an exchange history of the electronic mail documents.

39. A method for processing related documents, which comprises:
a detecting step of detecting relevance among documents; and
a locating step of locating a timewise latest document related to a document selected based on detected relevance information.

40. The method according to claim 39, wherein the documents have header information, and the detecting step includes detecting the relevance among the documents based on the header information.

41. The method according to claim 40, wherein the detecting step includes detecting a timewise order of the documents based on time information in the header information of each of the documents and outputting the relevance information including at least a timewise order.

42. The method according to claim 39, the locating step includes a displaying step of displaying contents of the located document.

43. The method according to claim 43, wherein the displaying step includes displaying the relevance among the documents as a tree view based on the relevance information detected by the detecting step.

44. The method according to claim 43, wherein the locating step includes processing a specific document as the selected document, the specific document selected among the documents displayed as a tree view by the displaying step.

45. The method according to claim 40, wherein the detecting step includes detecting a branched state between documents based on an ID noted in the header information according to a uniqueness rule in each of the documents and outputting the relevance information including at least the detected branched state.

46. The method according to claim 43, wherein the detecting step includes a branched state between documents based on an ID noted in the header information according to a uniqueness rule in each of the documents and outputting the relevance information including at least the detected branched state, and the displaying step includes displaying the relevance among the documents including the detected branched state as a tree view.

47. The method according to claim 39, wherein the documents are electronic mail documents, and the relevance information detected by the detecting step is an exchange history of the electronic mail documents.

48. The method according to claim 47, wherein a timewise latest electronic mail document located by the locating step is subjected to a return mail processing.

49. A method for processing related documents which comprises:
a detecting step of detecting relevance among documents; and
a merging step of parsing an overlapped portion among related documents based on detected relevance information and merging the documents with the overlapped portion eliminated.

50. The method according to claim 49, wherein the merging step includes merging the documents according to an order of the related documents.

51. The method according to claim 49, wherein the documents have header information, and the detecting step includes detecting the relevance among the documents based on the header information.

52. The method according to claim 51, wherein the detecting step includes detecting a timewise order of the documents based on time information in the header information of each of the documents and outputting the relevance information including at least the timewise order.

53. The method according to claim 49, wherein the detecting step including displaying the relevance among the documents as a tree view based on the detected relevance information.

54. The method according to claim 53, wherein the merging step includes merging documents from a document selected among the documents displayed as a tree view up to a timewise latest document related to the selected document, and the displaying step includes displaying the merged document.

55. The method according to claim 51, wherein the detecting step includes detecting a branched state between documents based on an ID noted in the header information according to a uniqueness rule in each of the documents and outputting the relevance information including at least the detected branched state.

56. The method according to claim 53, wherein the detecting step includes detecting a branched state between documents based on an ID noted in the header information according to a uniqueness rule in each of the documents and outputting the relevance information including at least the detected branched state, and the displaying step includes displaying the relevance among the documents including the detected branched state as a tree view.

57. The method according to claim 49, wherein the documents are electronic mail documents, and the relevance information detected by the detecting step is an exchange history of the electronic mail documents.
